(19) United States
(12) Patent Application Publication
(10) Pub. No.: US 2015/0302323 A1
(43) Pub. Date: Oct. 22, 2015

(54) SYSTEM AND METHOD FOR IMPROVING EFFICIENCY OF A WORKFORCE

(71) Applicant: General Electric Company, Schenectady, NY (US)

(72) Inventor: PAUL CONNOLLY, Erie, PA (US)

(73) Assignee: General Electric Company, Schenectady, NY (US)

(21) Appl. No.: 14/255,005

(22) Filed: Apr. 17, 2014

(51) Int. Cl. G06Q 10/06

(52) U.S. Cl. CPC G06Q 10/0633

(57) ABSTRACT

A method (e.g., for increasing the efficiency of a mission) includes tracking, with an electronic locating device, movements of an operator while the operator is performing a sequential series of tasks in a first order to complete a mission, examining the movements of the operator and completion of the tasks in the first order with one or more computer processors to determine if the tasks can be completed in a more efficient order than the first order, determining a different, second order of the tasks that is more efficient than the first order in which the tasks were completed when the movements of the operator were tracked, and generating a presentation of the second order of the tasks for display on an electronic mobile device during another performance of the tasks.

### FIELD

Embodiments of the subject matter described herein relate to improving the efficiency at which several tasks of a mission are performed on a system.

### BACKGROUND

Electro-mechanical systems, electrical systems, mechanical systems, and the like, periodically may need repair, maintenance, or preparation prior to performing functions for which the systems are designed to perform. For example, vehicles may require inspection, repair, maintenance, or the like, prior to departure. One specific example of such a vehicle is a locomotive. Before embarking on a trip, the locomotive may need to be inspected, maintained, or otherwise prepared. The inspection, repair, maintenance, preparation, and the like, of these systems can be referred to as a mission.

The mission may include several tasks (e.g., jobs) that need to be performed in order to complete the mission so that the system is ready to perform the designated function(s) of the system. Some of these tasks can require considerable resources in terms of personnel performing the tasks, the tools needed to complete the tasks, time needed to complete the tasks, or the like.

Over time, personnel that perform the tasks of the mission grow accustomed to completing the tasks in a particular order. But, this order may not be an efficient manner in which to complete the mission. For example, performing the tasks of the mission in a current or longstanding order can result in duplicative actions, movements, or the like, that cause the mission to be completed over a longer time period than may actually be necessary. As longer time periods are consumed with performing a mission, the assets used to perform the mission are prevented from working on other missions and/or systems. As a result, the rate at which the systems (on which the missions are performed) are ready to operate can decrease or be slower than necessary.

### BRIEF DESCRIPTION

In an embodiment, a method (e.g., for increasing the efficiency of a mission) includes tracking, with an electronic locating device, movements of an operator while the operator is performing a sequential series of tasks in a first order to complete a mission, examining the movements of the operator and completion of the tasks in the first order with one or more computer processors to determine if the tasks can be completed in a more efficient order than the first order, determining a different, second order of the tasks that is more efficient than the first order in which the tasks were completed when the movements of the operator were tracked, and generating a presentation of the second order of the tasks for display on an electronic mobile device during another performance of the tasks.

In another embodiment, a monitoring system includes a location receiving device and one or more computer processors. The location receiving device is configured to track movements of an operator while the operator is performing a sequential series of tasks in a first order to complete a mission. The one or more computer processors are configured to examine the movements of the operator and completion of the tasks in the first order to determine if the tasks can be completed in a more efficient order than the first order, determine a different, second order of the tasks that is more efficient than the first order in which the tasks were completed when the movements of the operator were tracked, and generate a presentation of the second order of the tasks for display on an electronic mobile device during another performance of the tasks.

In another embodiment, a method for increasing the efficiency at which a mission is completed includes identifying a previous order in which a series of tasks of a mission on a first vehicle were performed using tools and movements of an operator who performed the series of tasks in the previous order, and determining an alternate order to complete the series of tasks of the mission on a second vehicle. The alternate order includes at least one of a different sequence of the tasks or a different location of at least one of the tools. Completing the mission according to the alternate order of the tasks consumes less time than completing the mission according to the previous order of the tasks. The method also can include instructing, via a mobile electronic device that includes one or more computer processors, the operator how to move between the tools and the tasks according to the alternate order of the tasks during performance of the mission on the second vehicle, monitoring movements of the operator and completion of the tasks during performance of the mission on the second vehicle, and communicating a warning signal to the mobile electronic device responsive to determining that the operator is not performing the tasks of the mission according to the alternate order of the tasks.

### BRIEF DESCRIPTION OF THE DRAWINGS

The subject matter described herein will be better understood from reading the following description of non-limiting embodiments, with reference to the attached drawings, wherein below:

FIG. 1 is a schematic illustration of a workflow monitoring system in accordance with an embodiment of the invention;

FIG. 2 is a spatiotemporal data map according to an embodiment;

FIG. 3 illustrates a presentation of a current order of tasks of a mission that is displayed to an operator on an operator input device (or another device) according to an embodiment;

FIG. 4 illustrates a presentation of an alternate order of tasks of a mission that is displayed to an operator on the operator input device (or another device) according to an embodiment;

FIG. 5 illustrates an instructional presentation on the operator input device of a more efficient order in which tasks of a mission are to be completed according to an embodiment;

FIG. 6A illustrates part of a flowchart of an embodiment of a method for improving the efficiency of a workforce, such as that of one or more operators performing a series of tasks of a mission; and

FIG. 6B illustrates another part of the flowchart of the method for improving the efficiency of a workforce.

### DETAILED DESCRIPTION

One or more embodiments of the inventive subject matter described herein relate to systems and methods that monitor how multi-step tasks are currently being performed by an operator (e.g., a single or multiple human workforce), examine how these steps are performed to determine if there is a more efficient way in which to perform the steps, and visually presents the more efficient way (e.g., sequence) to perform the steps. The visual presentation of the more efficient way to perform the steps can be presented to the operator on one or more mobile devices, such as tablet computers, mobile phones, or the like, or on another device, so that the operator can view the more efficient sequence in which to perform the steps to achieve the task.

The monitoring of how the tasks are performed can involve spatially tracking movements of one or more operators as the operators move about an object being worked on (e.g., preparing a locomotive for departure, repair or maintenance on an automobile, or the like), tracking when various tasks are initiated and/or completed, determining the order in which the tasks are performed, and the like. The tasks may be performed sequentially and/or concurrently, and completion of the tasks results in completion of a mission. The mission can involve a variety of goals, such as preparing a vehicle (e.g., a locomotive, automobile, or the like) for departure, repair and/or maintenance of the vehicle, or preparing, repairing, and/or maintaining another type of object or system.

The current order in which the tasks are performed can be examined by determining if another order of the tasks results in the mission being completed more efficiently. For example, systems and methods described herein may determine if the current order of the tasks results in redundant movements of the operator (e.g., the operator backtracks over the same locations more than once in completing the tasks), if the placement of tools used by the operator in the current order of tasks can be changed to reduce the time needed to complete the mission and/or to reduce redundant movements of the operator, or the like.

Some of the tasks may be subject to restrictions on when the tasks can be performed relative to each other. For example, in a mission that requires performance of a first task, a second task, a third task, and so on, the third task may be unable to be completed until the first task has been successfully completed. One or more aspects of the systems and methods described herein may examine the current order of the tasks, the movements of the operator, the times at which the tasks are initiated and/or completed, locations of tools needed to complete the tasks, restrictions on the order in which the tasks can be completed, and the like, and determine one or more different orders in which the tasks can be completed to successfully perform the mission.

The one or more different orders of the tasks may be referred to as a recommended or efficient order of the tasks. Performance of the tasks in the recommended or efficient order on another vehicle or other object can result in the mission being completed more efficiently. For example, during preparation of another locomotive for departure from a rail yard, performance of the tasks for the mission of preparing the locomotive for departure in the recommended order can result in this locomotive being prepared for departure in less time than a previous locomotive (in which the tasks were performed in another order).

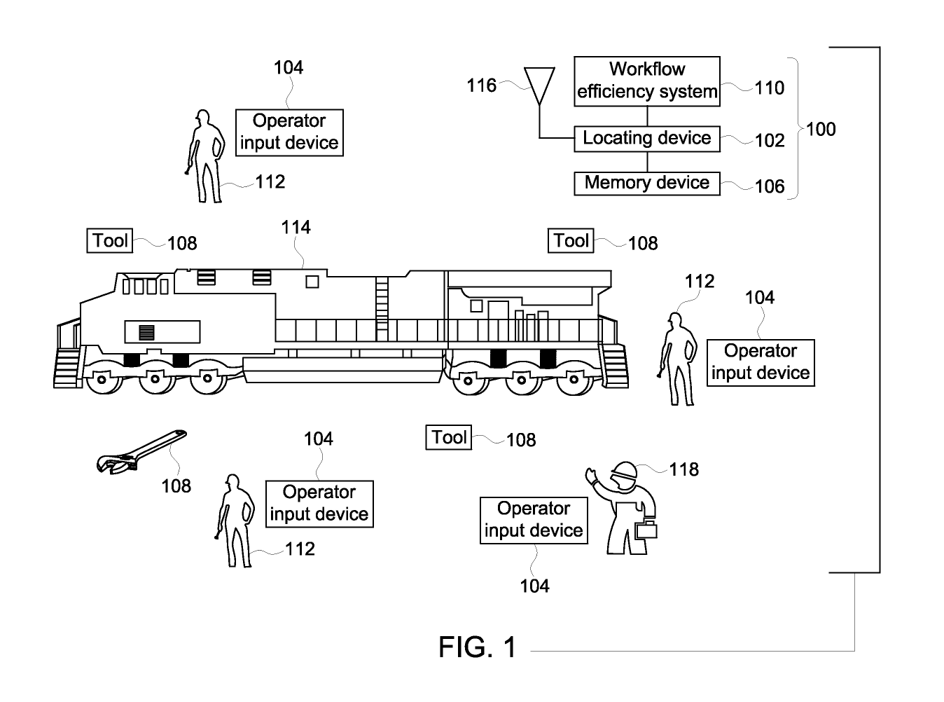

FIG. 1 is a schematic illustration of a workflow monitoring system 100 in accordance with one aspect of the inventive subject matter described herein. The system 100 can be used to monitor performance of a series of tasks that are completed in order to achieve a mission. In the illustrated example, the mission is the preparation of a locomotive for departure from a rail yard, but alternatively may involve another mission. For example, the mission may include the repair, maintenance, inspection, or other goal for a locomotive, another type of vehicle, or a non-vehicular system. Not all embodiments described herein are used to monitor the tasks performed in order to prepare a locomotive for departure.

The system 100 includes an electronic locating device 102 that monitors movements of one or more operators 112 that are performing one or more of the tasks of the mission. The operator may represent a single or several human beings performing the tasks on another system 114, such as a vehicle or other system. The system 100 optionally may monitor movements of one or more supervisors 118 of the operators 112 and/or report the movements of the operators 112 to the supervisors 118, such as persons who supervise, direct, or otherwise control activities of the operators 112.

The locating device 102 can include hardware circuits or circuitry that include and/or are connected with one or more processors, such as one or more computer microprocessors. In one aspect, the locating device 102 can include or represent a wireless triangulation system that monitors movements of an operator input device 104 that moves with the operator as the operator performs the tasks. For example, the locating device 102 can include one or more wireless antennas 116 and associated transceiving and/or receiving hardware that receives wireless signals communication signals communicated from the input device 104. Such an input device 104 can include a mobile phone, tablet computer, transponder, electronic beacon, radio frequency identification (RFID) tag, or the like. Optionally, the locating device 102 can include another device or system capable of tracking movements of the operator, such as one or more cameras, sensors (e.g., touch sensitive sensors on the floor that detect movements), RFID readers, or the like.

During performance of the tasks in the mission, the locating device 102 tracks where the operator moves during performance of tasks of the mission. The locating device 102 can monitor where the operator is located and store these locations in a memory device 106, such as a computer hard drive, flash drive, random access memory (RAM), read only memory (ROM), magnetic tape drive, optical drive, or other type of computer readable memory.

The locating device 102 optionally may track when various tasks of the mission are initiated and/or completed. In one aspect, the input device 104 accepts input from the operator. For example, the input device 104 can include a touchscreen, keypad, button, switch, microphone, or the like, that the operator uses to indicate when performance of one or more tasks is being initiated (e.g., the time at which the operator is starting work on a task). The locating device 102 optionally may track when the various tasks are completed and/or how long it takes for the operator to complete one or more of the tasks. For example, the input device 104 can receive input from the operator that indicates when one or more of the tasks are completed.

The locating device 102 may identify locations of one or more tools 108 used by the operator to perform one or more of the tasks needed to complete the mission. For example, if at least one of the tasks involves the operator measuring a wheel of a vehicle (e.g., the diameter or air pressure of a wheel), then the locating device 102 may determine the location of the device used to measure the diameter or air pressure of the wheel. As another example, if at least one of the tasks involves the operator adding, replacing, or otherwise examining a fluid of a vehicle (e.g., a cooling fluid, a lubricating fluid, or the like), then the locating device 102 may determine the location of a wrench or other tool used by the operator to gain access to the fluid of the vehicle. The locations of the tools 108 used to perform the tasks can be provided by the operator inputting the locations into the input device 104 (which are then communicated to the locating device 102 by the input device 104), the locations being preprogrammed into or otherwise provided to the locating device 102 and/or the memory device 106, the tools 108 being connected to a beacon, RFID tag, or other wireless antenna that provides the locations of the tools to the locating device 102, and the like.

The system 100 includes a workflow efficiency system 110 that examines the movements of the operators during performance of the tasks of the mission, when different tasks are initiated and/or completed, how long different tasks take to be completed, locations of the tools 108, and the like, and determines if the mission can be completed in a more efficient manner. For example, the workflow efficiency system 110 can determine if the tasks can be completed in another manner in order to successfully complete the same mission on another system (e.g., another vehicle) in less time, with less labor and/or parts costs, with reduced risk of harm to the operator, tools, and/or system being worked on, or the like. The workflow efficiency system 110 includes or represents hardware circuits or circuitry that include and/or are connected with one or more processors (e.g., one or more computer microprocessors).

The workflow efficiency system 110 can receive information such as the locations of the operators and/or tools 108 during performance of the tasks, the times at which different tasks are initiated and/or completed, and/or other information, from the locating device 102 and/or memory device 106. Using this information, the workflow efficiency system 110 can generate a spatial temporal map of the operator performing the tasks of the mission. While the description herein focuses on the locating device 102 tracking the movements of a single operator and the workflow efficiency system 110 examining performance of the tasks by a single operator, optionally, the locating device 102 may track the movements of several operators and the workflow efficiency system 110 can examine performance of the tasks by several different operators.

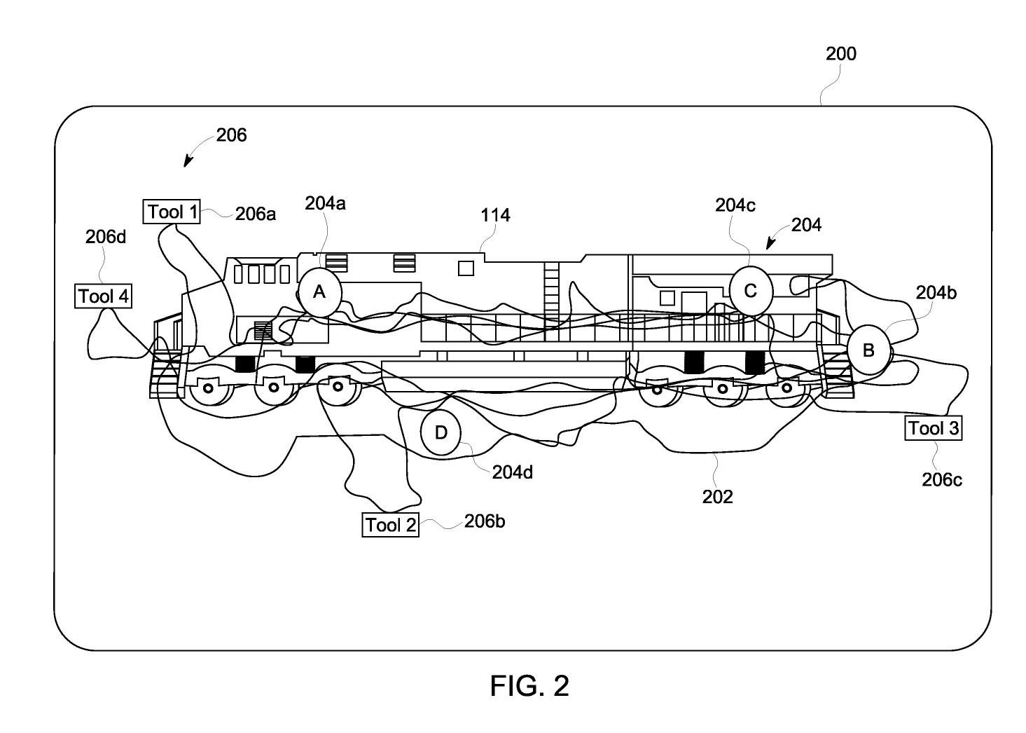

FIG. 2 is a spatiotemporal data map 200 according to one example of the inventive subject matter described herein. The map 200 represents movements of the operator 112 at different times during performance of the tasks in a mission, such as preparing a locomotive for departure (or another type of vehicle or mission). The workflow efficiency system 110 can generate the map 200 using the locations of the operator that are tracked by the locating device 102. The map 200 may be generated so as to be displayed on a computer device, such as a laptop computer, tablet computer, mobile phone, desktop computer, or other device. The map 200 includes several movement lines 202 representative of locations of the operator at different times, and the paths traveled by the operator to move between these locations. The map 200 also may include task indicators 204 (e.g., indicators 204a-d), which graphically represent locations where a task of the mission was initiated and/or completed. The map 200 can include tool indicators 206 (e.g., indicators 206a-d), which graphically represent locations of the tools 108 used by the operator. The movements of the operators may be tracked as three dimensional movements.

The map 200 can be examined by the workflow efficiency system 110 to identify extraneous, redundant, or other actions by the operator that result in an inefficient completion of the tasks of the mission. For example, the workflow efficiency system 110 can examine the movements of the operator in performing a sequential series of tasks to determine if the movements overlap. In the illustrated example, there are four tasks (represented by task indicators 204a-d) that are performed by the operator to complete the mission of repairing a component of the vehicle 114. Optionally, a greater or smaller number of tasks may be performed. A first task (represented by task indicator 204a) is performed first using a first tool (represented by tool indicator 206a), then a second task (represented by task indicator 204b) is performed using a second tool (represented by tool indicator 206b), then a third task (represented by task indicator 204c) is performed using a third tool (represented by tool indicator 206c), and then a fourth task (represented by task indicator 204d) is performed using a fourth tool (represented by tool indicator 206d). Optionally, a greater or smaller number of tools may be used to perform the tasks.

The workflow efficiency system 110 can determine the movements and/or the movement lines 202 of the operators based on the locations of the operators that were tracked by the locating device 102 and the times at which these locations were determined by the locating device 102. As shown by the movement lines 202 in FIG. 2, the movements of the operators in completing the four tasks extend around the vehicle 114 several times, and frequently overlap one another. The movement lines 202 that are shown on the vehicle may represent movements of the operators on an opposite (e.g., hidden from view) side of the vehicle. The workflow efficiency system 110 can determine that the movements of the operators and/or completion of the tasks of the mission may be completed in a more efficient manner in one or more ways. For example, the workflow efficiency system 110 can compare the time elapsed for the operators to complete one task, a series of the tasks, or all of the tasks of the mission, and compare this elapsed time to one or more designated time thresholds. If the elapsed time that it takes for the operators to actually complete the task, series of tasks, or all of the tasks exceeds the associated time threshold, then the workflow efficiency system 110 may determine that the order of the tasks and/or positions of one or more tools may need to be modified to reduce the time needed to complete the mission again.

As another example, the workflow efficiency system 110 can determine that the tasks can be completed in a more efficient manner by comparing the movements (e.g., the movement lines 202) and determine if at least a percentage, fraction, or other measurement of the movements overlap one another. By “overlap,” it is meant that the movements of the operator move over the same locations at different times or within a non-zero designated buffer distance of one or more previous movements of the operator. For example, the movement lines 202 that are shown as being on the vehicle (and that actually can represent movements of the operator on the other side of the vehicle) show significant overlap. This can indicate that the operator is moving back-and-forth over the same areas during performance of the tasks. This back-and-forth movement can be wasteful of the time needed to complete the mission.

Once the workflow efficiency system 110 determines that the tasks can be completed in a more efficient manner (and thereby reduce the time needed to complete performance of the mission), the workflow efficiency system 110 attempts to identify one or more different orders in which the tasks of the mission can be performed and/or one or more different locations of the tools used to perform the tasks of the mission. The different orders and/or tool locations can be used to determine a more efficient order in which the tasks can be completed.

For example, with the four tasks represented by task indicators 204a, 204b, 204c, 204d being performed in that order, the workflow efficiency system 110 can attempt to change the order of the tasks. The workflow efficiency system 110 can determine if there are any restrictions on the order in which these tasks are performed. A first task (e.g., task indicator 204a) may be required to be performed prior to performance of a second task (e.g., task indicator 204b) because the components and/or tools used in performance of the second task may not be accessible, safe to operate on, or otherwise unavailable until after the first task is completed. As one example, measurement of a diameter of a wheel of the vehicle may need to be performed prior to calibrating a speed sensor of the vehicle (that is based on the diameter of the wheel and how fast the wheel rotates). As another example, draining oil from an automobile may need to be performed prior to replacing an oil filter of the automobile, which may need to be performed prior to refilling oil into the automobile. As another example, deactivation of an engine may need to be performed prior to opening a cooling system of the engine and may need to be performed at least a designated time period prior to opening the cooling system to allow a temperature of the cooling system to be reduced to a safe level.

The workflow efficiency system 110 may generate one or more alternate or replacement orders of the tasks of the mission and calculate an estimated time to completion for these alternate orders of the tasks. The alternate or replacement orders may be subject to restrictions on which tasks are required or limited to being performed before or after one or more other tasks, as described above. These restrictions may be stored in the memory device 106. In one aspect, the workflow efficiency system 110 may randomly or otherwise change the order of the tasks into an alternate order, without violating the restrictions on the order of the tasks. The workflow efficiency system 110 can then calculate an estimated time of completion of the tasks in the alternate order.

In one aspect, the workflow efficiency system 110 can estimate the times of completion of the tasks in an alternate order based on designated completion time periods associated with the tasks and distances between locations on the system 114 where the tasks are to be performed. For example, each of the tasks may be associated with a designated time period that the operator is expected to take to complete the task. Additionally, the locations at which the tasks are to be performed on the system 114 (e.g., as represented by the task indicators 204 in the map 200), the locations of the tools used to perform the tasks (e.g., as represented by the tool indicators 206 on the map 200), and/or the alternate order of the tasks may be used to estimate how long it will take the operator to move to the tool locations and/or task locations in the alternate order. The workflow efficiency system 110 may use a designated or estimated speed at which the operator moves, as well as the distances between the tools and/or tasks in the alternate order, and calculate an estimated movement time for the alternate order of the tasks. This estimated movement time represents how long it is expected to take the operator to move between the tasks in the alternate order.

Additionally or alternatively, the workflow efficiency system 110 may modify the estimated completion time periods for one or more of the tasks based on workforce restrictions. A workforce restriction includes a limitation on how long the operator or operators are permitted to work, such as by contractual agreement, legal restriction, to avoid additional compensation (e.g., overtime), or otherwise. The workflow efficiency system 110 can lengthen the estimated completion time period for a task when the task would involve one or more of the operators working in excess or violation of a workforce restriction. The workforce restrictions may be stored on and accessible to the workflow efficiency system 110 from the memory device 106, and estimated times for the operator to inform another operator as to the status of the task also may be stored on and accessible to the workflow efficiency system 110 from the memory device 106.

For example, if, in the alternate order of tasks, an operator would be required by a workforce restriction to take a break or stop work on the task before completion of the task due to the scheduled end of a working shift (e.g., completion of the task would require the operator to work over lunch, work in excess of an eight hour work shift or other length of time, or the like), then the workflow efficiency system 110 may extend the estimated completion time period for the task. The estimated completion time may be extended until the following time at which the operator is permitted by the workforce restriction to return to working on the task, until it is estimated that the operator will be able to inform another operator as to the status of the task, or the like.

In one aspect, an alternate order of the tasks may be eliminated from consideration due to one or more tasks being unable to be completed within a time period designated by a workforce restriction. For example, an alternate order of the tasks may involve a first task being started sufficiently late in a work shift that the first task cannot be completed before the end of the work shift. The location of the first task in the alternate order and the estimated completion time for the first task may result in the first task not being completed before the end of the work shift. As a result, the workflow efficiency system 110 may discard the alternate order from consideration as a new order for the tasks.

Optionally, the workflow efficiency system 110 may modify the estimated completion time periods for one or more of the tasks based on changing the locations of the tools used to perform the tasks. The workflow efficiency system 110 may measure or access a previously stored distance between the locations at which the various tasks are to be performed on the system 114 and the current locations of the tools used to perform the various tasks. As described above, the locating device 102 can determine current locations of the tools. The associations between which tools are used to perform which tasks can be stored in the memory device 106 and accessible to the workflow efficiency system 110 from the memory device 106.

The workflow efficiency system 110 can calculate estimated movement times for the operator to move to the location of a tool (e.g., from a previous tool, a previously completed task, or the like) based on an estimated or actual moving speed of the operator (e.g., as determined by the data obtained from the locating device 102), the distance from the previous tool, task, or the like, and/or the distance from the tool to the location of the next task in the alternate order of tasks. The workflow efficiency system 110 can simulate moving locations of the tools (e.g., randomly moving the tools, moving the tools closer to the locations of the associated tasks in which the tools are used, moving the tools closer to the location of a previously completed task, moving the tools closer to the location of a subsequent task, or the like), and calculate estimated movement times based on the different locations of the tools in the alternate orders of tasks.

The workflow efficiency system 110 may then calculate a total estimated time for completion of the tasks in the alternate order. The workflow efficiency system 110 additionally or alternatively may calculate several additional total estimated times for completion of the tasks for each, or at least one, of the alternate orders. The additional total estimated times for an alternate order of the tasks may be calculated for different locations of the tools.

The total estimated times may be sums or other combination of the estimated movement times and the designated completion time periods associated with the tasks in each or one or more of the alternate orders. In one aspect, the designated completion time periods of the tasks may change based on the order in which the tasks are to be completed. Some tasks may be estimated as requiring longer or shorter time periods when other tasks are performed before or after other tasks. For example, a first task may be associated with a longer designated time period when the first task is performed (or scheduled to be performed) before a second task. When the second task is scheduled before the first task in the alternate order, however, the first task may be associated with a shorter time period for completion. The time period for completion of the first task may be shortened due to additional resources (e.g., additional operators, tools, or the like) being available to complete the first task when the second task is already completed, due to the second task involving some of the same components of the first task (such that some of the work for the first task is completed during completion of the second task), or the like. Alternatively, the time period for completion of the first task may be lengthened due to fewer resources (e.g., fewer operators, tools, or the like) being available to complete the first task when the second task is before the first task (such as due to the fact that the second task may require more resources than the first task and may need to be performed at the same time as the first task), due to the second task involving some of the same components of the first task (such that these components are unavailable for a time period following the second task), or the like.

The workflow efficiency system 110 can calculate total estimated times for completion of the tasks in several different alternate orders (and/or with new tool locations), and compare these total estimated times. The workflow efficiency system 110 may select the alternate order from among these alternate orders. As described above, some alternate orders may involve the same order of tasks, but with different locations of the tools. The alternate order that is selected may be referred to as a replacement order or an efficient order of the tasks in that the selected order of the tasks may be estimated to require less time and/or cost to complete the mission than the current order and/or than one or more (or all) of the other alternate orders.

Instead of or in addition to changing the sequence in which the tasks are scheduled to be completed, the workflow efficiency system 110 may alter the order of the tasks by changing the number of operators, tools, and/or equipment used in completing the tasks. For example, the workflow efficiency system 110 can increase the number of operators scheduled to work on the tasks, can increase the number of operators having specialized experience or certifications to work on the tasks, or the like.

Optionally, the order of the tasks may be modified by changing which tasks are assigned to different operators. For example, a first task may originally be assigned to a first operator for completion, a second task may be assigned to second and third operators for completion, a third task may be assigned to fourth through seventh operators for completion, and the like. The workflow efficiency system 110 can modify the order of the tasks by changing how many operators and/or which operators are assigned to complete different tasks. The assignment of which operators perform which tasks can be based on specialized experience and/or certifications of the operators, past efficiencies of the operators in completing the various tasks, or the like. For example, if the first and sixth operators have been specially trained and/or certified to complete the second task, then the order of tasks may be modified by assigning the first and sixth operators to complete the second task. If the fifth operator has a history of completing the first task faster than other operators, then the order of the tasks can be modified by re-assigning the first task to the fifth operator. The remaining tasks can be assigned to the other operators.

In one aspect, the workflow efficiency system 110 can determine the alternate orders of the tasks, the estimated times for completion, the various different tool locations, and the like, based on several repetitions of the tasks for a given or designated mission. For example, over time, the workflow efficiency system 110 can monitor the movements of operators performing the same (or substantially similar) mission on several systems 114. The workflow efficiency system 110 can identify and select an alternate, more efficient order of the tasks (which may or may not include different tool locations) based on the several iterations of performing the same or substantially same mission. In doing so, significant aberrations in the time needed to perform one or more tasks during a relatively small number of missions may not adversely affect identification of a more efficient alternate order of the tasks.

Optionally, the workflow efficiency system 110 can track efficiencies of the operators in completing the tasks and modify the order of the tasks based on these efficiencies. For example, as the same operators complete the same tasks one or more times, the workflow efficiency system 110 can monitor and save the time periods required to complete the tasks for the different operators, problems encountered by the different operators, injuries to the operators, damage to the tools, equipment, and/or assets, or other information. This information can then be used to determine if one or more scheduled tasks should be re-assigned to other operators. For example, a first operator may historically complete a task in less time, with fewer problems, with fewer injuries, and/or with less damage than a second operator. If the second operator is previously scheduled to complete the task, the order of the tasks can be modified by assigning the first operator to complete the task instead of the second operator.

Optionally, the workflow efficiency system 110 can track efficiencies of different facilities or other locations in completing the tasks, and can modify the order of the tasks based on these efficiencies. For example, as the operators at different facilities or other locations complete the same tasks one or more times, the workflow efficiency system 110 can monitor and save the time periods required to complete the tasks for the different facilities or other locations, problems encountered by the different facilities or other locations, injuries to the operators at the facilities or other locations, damage to the tools, equipment, and/or assets at the facilities or other locations, or other information. This information can then be used to determine if one or more scheduled tasks should be re-assigned to other facilities or other locations. For example, operators at a first facility may historically complete a task in less time, with fewer problems, with fewer injuries, and/or with less damage than the operators at a second facility. If operators at the second facility are previously scheduled to complete the task, the order of the tasks can be modified by assigning the operators at the first facility to complete the task instead of the operators at the second facility.

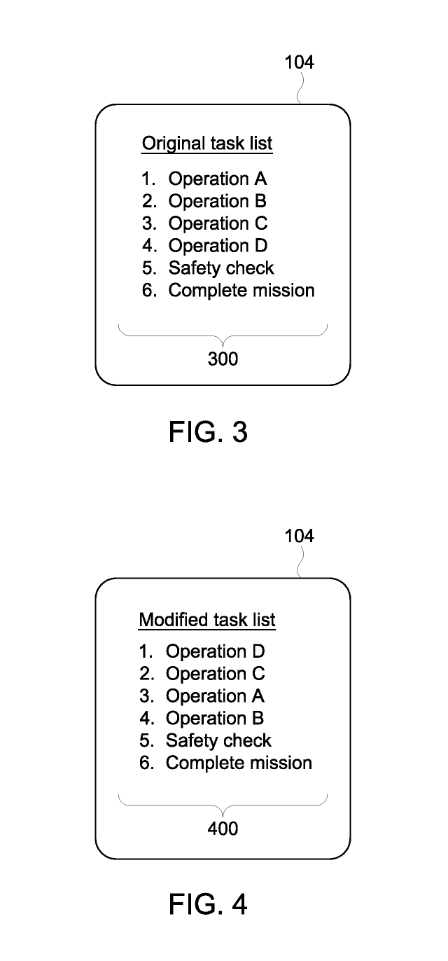

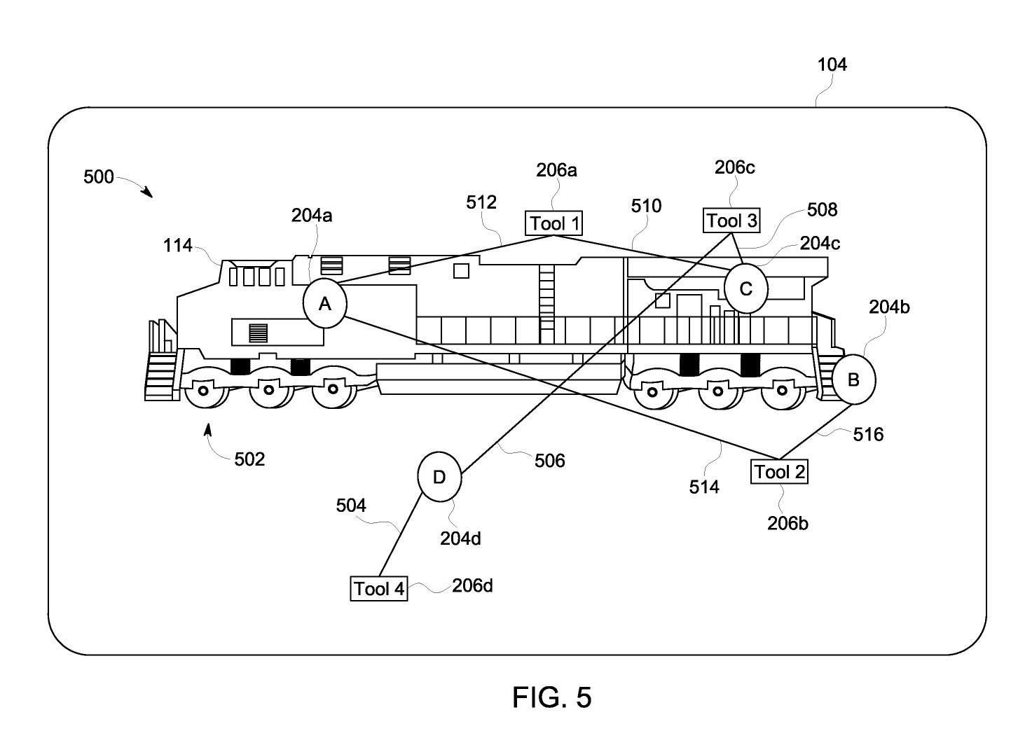

FIG. 3 illustrates a presentation 300 of a current order of tasks of a mission that is displayed to an operator on the operator input device 104 (or another device) according to one example of the inventive subject matter described herein. FIG. 4 illustrates a presentation 400 of an alternate order of tasks of a mission that is displayed to an operator on the operator input device 104 (or another device) according to one example of the inventive subject matter described herein. The operator input device 104 may present the orders of the tasks shown in the presentations 300, 400 to the operator so that the operator is informed as to which tasks are to be completed in which order. During one performance of the mission, the presentation 300 instructs the operator to perform a first task (“Operation A” in the presentation 300 of FIG. 3), then a second task (“Operation B” in the presentation 300 of FIG. 3), then a third task (“Operation C” in the presentation 300 of FIG. 3), then a fourth task (“Operation D” in the presentation 300 of FIG. 3), then a fifth task (“Safety Check” in the presentation 300 of FIG. 3), before concluding the mission (“Complete Mission” in the presentation 300 of FIG. 3).

During performance of the mission according to the presentation 300, however, the locating device 102 may track the operator and the workflow efficiency system 110 may determine that a different, alternate order of the tasks (which may or may not include different tool locations) may be a more efficient way to complete the mission. As a result, during another performance of the mission (on the same or different system 114), the workflow efficiency system 110 can generate one or more control signals that are communicated (via one or more wired and/or wireless connections) to the operator input device 104 for display as the presentation 400.

As shown in FIG. 4, the order of the tasks has been modified. In the alternate, more efficient order of the tasks, the fourth task (“Operation D”) is performed first, followed by the third task (“Operation C”), the first task (“Operation A”), the second task (“Operation B”), and the fifth task (“Safety Check”), before completing the mission. In this example, the workflow efficiency system 110 may generate the alternate order of the tasks subject to one or more order restrictions, such as by being limited to having the second task (“Operation B”) occur after the first task (“Operation A”). For example, the workflow efficiency system 110 may be not be permitted by the order restriction to place the second task (“Operation B”) ahead of the first task (“Operation A”). Additionally, another restriction may limit where the fifth task may be located in the alternate order of tasks. For example, the fifth task (“Safety Check”) may be restricted to occurring only after the first through fourth tasks have been completed.

The workflow efficiency system 110 optionally may generate a visual presentation of the more efficient order of the tasks for display to the operator in order to guide the operator through performance of the tasks for completion of the mission on another system 114. For example, after determining the more efficient order of the tasks (which may or may not include new positions for one or more of the tools), the workflow efficiency system 110 may communicate signals to the operator input device 104 that direct the operator input device 104 to visually present the more efficient order of the tasks, the new locations of the tools, and/or movement paths that the operator should take when moving between tasks and/or to and from the tools.

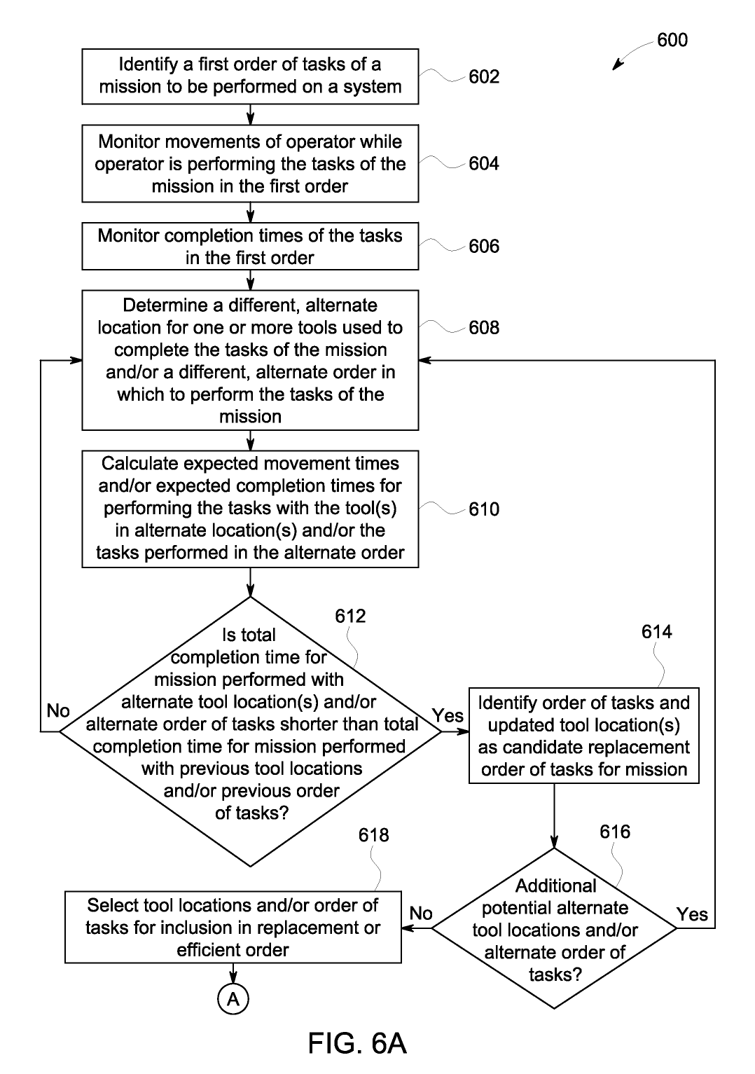

FIG. 5 illustrates an instructional presentation 500 on the operator input device 104 of a more efficient order in which tasks of a mission are to be completed according to one example of the inventive subject matter described herein. The instructional presentation 500 is generated by the input device 104 based on signals received from the workflow efficiency system 110. These signals may indicate where the task indicators 204 and/or tool indicators 206 are to be displayed relative to an image 502 of the system 114 that is shown to the operator on the input device 104. Optionally, the presentation 400 of the updated order of tasks may be shown within the presentation 500 of the task and tool indicators 204, 206. Alternatively, the presentation 400 of the updated order may be shown on a different screen or device than the presentation 500 of the task and tool indicators 205, 206.

As shown in the presentation 500 of FIG. 5, some of the tools have been moved to different locations in the updated (e.g., alternate) order of the tasks. As described above, the tools may have been moved to reduce the time spent by the operator moving around the system 114 to obtain the tools needed for performance of the tasks.

The operator may view the new order of the tasks (e.g., from the presentation 400) and/or the new locations of the tools (e.g., from the tool indicators 206 in the presentation 500) as shown on the input device 104 in order to understand the updated order of the tasks and/or the changed location of one or more tools, and to perform the tasks to complete the mission. Optionally, the task indicators 204 may represent the order in which the tasks are to be completed. For example, the task indicators 204 may include numbers or other indicia that represents the order in which the associated tasks are to be performed.

The operator may then commence performing the tasks in the updated order and/or with the updated locations of the tools. During performance of the tasks, the locating device 102 may track movements of the operator, times at which the tasks are begun and/or completed, the order in which the tasks are completed, the location of the tools, and the like. The locating device 102 may compare one or more of these actual movements, times, completion orders, or locations to movements, times, completion orders, or locations that are designated by the updated order of the tasks. For example, the updated order of the tasks may represent an updated schedule of the tasks, and can indicate the order in which the tasks are to be completed, expected completion times for the tasks, expected locations of the tools, and the like.

If, during the performance of the tasks according to the updated order, the locating device 102 monitors the movements of the operator and completion of the tasks, and the workflow efficiency system 110 determines if and/or when the operator is performing the tasks in another order (e.g., other than the updated order), the operator is moving from a first task to a second task that is not subsequent or immediately subsequent to the first task in the updated order, the operator is moving to or from an incorrect tool to or from a task, the operator is moving to or from an incorrect task to or from a tool, the operator is taking too long to complete a task (e.g., completion of the task is taking longer than a designated completion time), or the like.

For example, the workflow efficiency system 110 may determine that, according to the updated order of the tasks (as shown in the presentation 400 of FIG. 4), the designated completion times of the tasks, and/or calculated movement times of the operator, performance of the mission should involve (in the order listed below):

(1) the operator moving from at or near the fourth tool (e.g., as represented by the fourth tool indicator 206d) to the location of the fourth task (e.g., as represented by the fourth task indicator 204d), with the movement of the operator represented by a first movement line 504 in the presentation 500 of FIG. 5,

(2) the operator remaining at or near the location of the fourth task (e.g., at or near the location of the fourth task indicator 204d) for performance of the fourth task for a designated completion time associated with the fourth task (e.g., approximately ninety minutes or less),

(3) completion of the fourth task being automatically and/or manually reported by to the locating device 102 and/or the workflow efficiency system 110 by the operator and/or the input device 104 prior to completion of another task,

(4) the operator moving from at or near the location of the fourth task to a location that is at or near the third tool (e.g., as represented by the third tool indicator 206c), with the movement of the operator represented by a second movement line 506 in the presentation 500 of FIG. 5,

(5) the operator moving from at or near the third tool to the location of the third task (e.g., as represented by the third task indicator 204c), with the movement of the operator represented by a third movement line 508 in the presentation 500 of FIG. 5,

(6) the operator remaining at or near the location of the third task (e.g., at or near the location of the third task indicator 204c) for performance of the third task for a designated completion time associated with the third task (e.g., approximately thirty minutes or less),

(7) completion of the third task being automatically and/or manually reported by to the locating device 102 and/or the workflow efficiency system 110 by the operator and/or the input device 104 prior to completion of another task,

(8) the operator moving from at or near the location of the third task to a location that is at or near the first tool (e.g., as represented by the first tool indicator 206a), with the movement of the operator represented by a fourth movement line 510 in the presentation 500 of FIG. 5,

(9) the operator moving from at or near the first tool to the location of the first task (e.g., as represented by the first task indicator 204a), with the movement of the operator represented by a fifth movement line 512 in the presentation 500 of FIG. 5,

(10) the operator remaining at or near the location of the first task (e.g., at or near the location of the first task indicator 204a) for performance of the first task for a designated completion time associated with the first task (e.g., approximately 120 minutes or less),

(11) completion of the first task being automatically and/or manually reported by to the locating device 102 and/or the workflow efficiency system 110 by the operator and/or the input device 104 prior to completion of another task,

(12) the operator moving from at or near the location of the first task to a location that is at or near the second tool (e.g., as represented by the second tool indicator 206b), with the movement of the operator represented by a sixth movement line 514 in the presentation 500 of FIG. 5,

(13) the operator moving from at or near the second tool to the location of the second task (e.g., as represented by the second task indicator 204b), with the movement of the operator represented by a seventh movement line 516 in the presentation 500 of FIG. 5,

(14) the operator remaining at or near the location of the second task (e.g., at or near the location of the second task indicator 204b) for performance of the second task for a designated completion time associated with the second task (e.g., approximately sixty minutes or less),

(15) completion of the second task being automatically and/or manually reported by to the locating device 102 and/or the workflow efficiency system 110 by the operator and/or the input device 104 prior to completion of another task, and

(16) any additional movements and/or tasks designated by the updated order of tasks.

The workflow efficiency system 110 can determine if the operator is “at or near” a designated location (e.g., a tool location or task location) by identifying whether the operator is within a designated distance from the designated location, such as within a few centimeters or meters.

If the workflow efficiency system 110 determines that the operators are not performing the tasks in the alternate order and/or is taking longer than the designated completion times of the tasks to complete the tasks, then the workflow efficiency system 110 can identify a deviation from the alternate order. For example, the workflow efficiency system 110 may examine the actual movements of the operators, the actual times needed to complete the tasks, the order in which the tasks are actually completed, and the like, and compare this information to the expected movements of the operators (if the operators were following the more efficient alternate or replacement order of tasks), the order of the tasks in the more efficient alternate or replacement order, and the like. Based on this comparison, the workflow efficiency system 110 can determine if the operators are deviating from the more efficient alternate or replacement order. If the operators are deviating from the alternate order, then the workflow efficiency system 110 may instruct the input device 104 and/or another device to generate a warning signal. This warning signal may notify the operators and/or management of the operators of the deviation, may instruct the operators how to return to following the more efficient alternate order of tasks, and/or may automatically reschedule or reorder at least some of the remaining tasks in the alternate order so as to reduce any delay in completion of the mission (relative to not reordering the tasks).

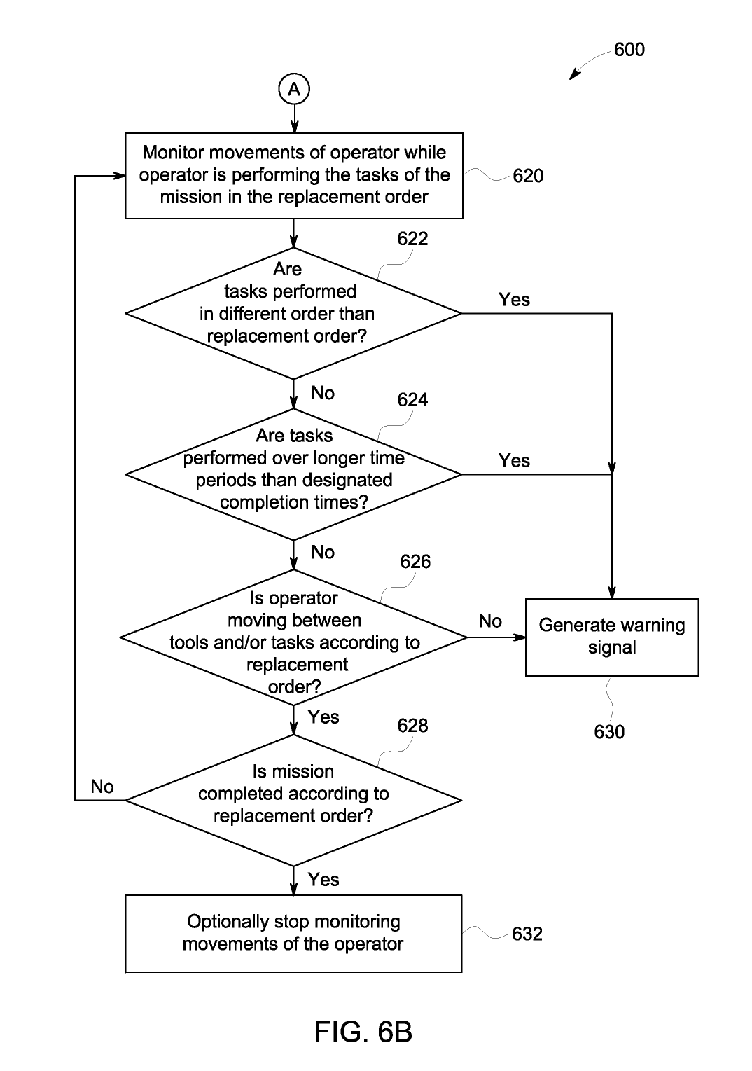

FIGS. 6A and 6B illustrate a flowchart of a method 600 for improving the efficiency of a workforce, such as that of one or more operators performing a series of tasks of a mission. The flowchart of the method 600 is divided between the two FIGS. 6A and 6B. The encircled letter “A” in FIGS. 6A and 6B is used to indicate where flow of the method 600 proceeds from operation 618 in FIG. 6A to operation 620 in FIG. 6B.

The method 600 may be used to increase the efficiency of a workflow, such as the workflow of repairing, maintaining, and/or preparing a vehicle (e.g., system 114) for departure, as described above. The efficiency of the workflow (e.g., performance of the tasks of the mission) can be increased by reducing the total time period needed to complete the mission of repairing, maintaining, and/or preparing the system 114. Optionally, the efficiency of the mission can be increased by reducing the cost of completing the mission. For example, the number of operators needed to complete the mission may be reduced by identifying an alternate order of the tasks in the mission that requires fewer operators to complete the tasks of the mission. As another example, fewer assets (e.g., tools, replacement parts or materials, goods that are consumed by performance of the mission, or the like) may be required to complete the mission when the tasks of the mission are performed according to the alternate order of tasks relative to completing the mission with a currently used order of tasks.

At 602, a first order (e.g., a currently used order) of tasks in a mission to be performed on a system (e.g., a vehicle) is identified. This order may be obtained from a memory, such as the memory device described above. Optionally, the order may be input by an operator or other person, such as an operator inputting the order into the workflow efficiency system described above (e.g., directly and/or via the operator input device).

At 604, the movements of one or more operators performing the tasks of the mission according to the first order are monitored. In one aspect, the identification of the first order of tasks (e.g., at 602) may be performed while the movements of the operator are being monitored. At 606, completion of the tasks in the mission is monitored. For example, the times at which various tasks are initiated, performed, and/or completed may be determined

At 608, a different, alternate location for one or more tools used to complete the tasks of the mission and/or a different, alternate order for one or more of the tasks in the mission are determined. As described above, moving the location of one or more tools relative to the system on which the tasks are performed may result in performance of the mission becoming more efficient. Optionally, changing the order in which the tasks are performed to complete the mission can increase the efficiency of completing the mission, also as described above. Some of the tools and/or tasks may be subject to restrictions that do not permit movement of the tools and/or changing the order of the tasks. For example, the location of one or more tools may be fixed such that the location cannot be changed (e.g., the tool may be affixed to a surface that does not allow movement of the tool, the tool may be concurrently used by several different operators performing tasks for different missions, or the like). As another example, some tasks may need to be performed before or after other tasks. The new locations of the tools and/or order of the tasks may be referred to as an alternate or replacement order. As described above, changing the order of the tasks may involve altering which operators and/or facilities are assigned to complete one or more of the tasks, changing the number of operators are assigned to complete the tasks, or the like.

At 610, expected movement times of the operator(s) and/or expected completion times for performing the tasks of the mission are calculated. As described above, the expected time periods over which the operator moves to and from the tools in the previous locations and/or new locations may be calculated, such as from a designated moving speed of the operator, the distances between the tasks and the tools, and the like. Optionally, the expected time periods over which the tasks in the alternate order are to be completed can be calculated. These expected time periods may be designated time periods, such as time periods calculated from previous performances of the tasks, designated time periods from an industry standard, or the like.

At 612, a total calculated completion time for the tasks of the mission in the alternate order is compared to a total actual completion time in which the tasks of the mission in the previous order are compared. For example, the actual time in which the tasks were completed by the operator according to previous tool locations and/or a previous order of the tasks is calculated and compared to the calculated time in which the tasks are expected to be completed by the operator according to the alternate tool locations and/or alternate order of the tasks. If the total completion time for the alternate order of tasks (and/or tool locations) is less than the total completion time for the previous order of tasks (and/or tool locations), then the alternate order of tasks (and/or tool locations) may be used to replace the previous order of tasks. As a result, flow of the method 600 can proceed to 614.

Alternatively, the total completion time for the alternate order of tasks (and/or tool locations) is not less than the total completion time for the previous order of tasks (and/or tool locations), then the alternate order of tasks (and/or tool locations) may not be used to replace the previous order of tasks. As a result, flow of the method 600 may return to 608.

At 614, the alternate task order (and/or tool locations) is identified as a candidate replacement order of the tasks in the mission. For example, the alternate order and/or tool locations that are calculated as completing the mission faster than the current order and/or tool locations may be identified as a potential replacement for the current order of tasks.

At 616, a determination is made as to whether one or more additional alternate tool locations and/or task orders are to be examined. For example, another alternate order of the tasks and/or another alternate location for one or more of the tools may be identified, and the total completion time for the additional alternate task order and/or tool locations may be calculated. The method 600 can identify these alternate orders and/or tool locations by determining if the tasks can be performed in an order that has not yet been examined (e.g., the completion times have not been calculated) and/or if the tools can be moved to any other locations. As described above, the order of some tasks and/or the locations of one or more tools may be subject to restrictions that limit how the tasks may be reordered and/or how the tools may be relocated. These restrictions can limit the total amount of alternate task orders and/or tool locations.

If one or more additional alternate task orders and/or tool locations may be examined to determine if the alternate task orders and/or tool locations are more efficient than another task order and/or tool location, then flow of the method 600 can return to 608. The total completion times for several alternate task orders and/or tool locations may therefore be calculated and compared to each other and/or to the previous performance of the tasks of the mission (e.g., at 604). Based on these comparisons, one or more alternate orders of the tasks (and/or alternate tool locations) may be identified as being more efficient to complete the mission than the current or previous order (and/or tool locations).

On the other hand, if no additional alternate task orders and/or tool locations are to be examined, then flow of the method 600 may proceed to 618. At 618, a candidate replacement order is selected for implementation. For example, of the alternate task orders and/or alternate tool locations that were identified at 614 as being more efficient than the current task order and/or tool location (and/or than one or more other alternate task orders and/or tool locations), the candidate task order and/or tool location that is more efficient than one or more other candidate task orders and/or tool locations (or the most efficient candidate task order and/or tool location) is selected for use in performing the mission on another system.

Flow of the method 600 can proceed from 618 shown in FIG. 6A to 620 shown in FIG. 6B.

At 620, actual movements of the same or other operator are monitored while the operator performs the tasks of the mission according to the replacement order selected at 618. As described above, the movements of the operator, the times at which performance of the tasks are commenced and/or completed, the order in which the tasks are actually completed, and the like, can be tracked.

At 622, 624, 626, several checks on performance of the mission according to the replacement order can be conducted. Not all checks of 622, 624, 626 need to be performed in all embodiments of the inventive subject matter described herein. In the illustrated example, a determination is made as to whether the tasks are being performed by the operator in the same order as the replacement order of tasks (at 622). If the operator is performing the tasks in the same order as the replacement order that was selected at 618, then the more efficient order of the tasks is being followed, and no alarm or warning may be needed. Therefore, flow of the method 600 can proceed to 624. On the other hand, if the operator is not performing the tasks in the same order as the replacement order that was selected at 618, then the more efficient order of the tasks is not being followed, and an alarm or warning may be needed to inform the operator or one or more other persons. Therefore, flow of the method 600 can proceed to 630.

At 624, a determination is made as to whether the tasks are being performed in a timely manner. For example, the actual time periods over which the tasks are being completed are compared to designated time periods associated with the tasks. The designated time periods can represent the time periods over which the tasks are expected to be completed, as described above. If the tasks are not being completed within the designated time periods, then some error, accident, or other cause may be preventing the operator from following the replacement order of the tasks. As a result, an alarm or warning may be needed. Therefore, flow of the method 600 can proceed to 630. On the other hand, if the tasks are being completed within the designated time periods, then no alarm or warning may be needed. Therefore, flow of the method 600 can proceed to 626.

At 626, a determination is made as to whether the operator is moving to and from the tools and/or the locations of the tasks according to the replacement order of the tasks. For example, the actual movements of the operator can be compared to the paths between locations of the tools and/or the locations of where the tasks are to be performed to determine if the operator is moving between the tools and task locations in a manner that follows the replacement order of the tasks. If the operator is moving between the tools and task locations in a manner that follows the replacement order of the tasks, then no alarm or warning may be needed, and flow of the method 600 can proceed to 628. On the other hand, if the operator is not moving between the tools and task locations in a manner that follows the replacement order of the tasks, then an alarm or warning may be needed, and flow of the method 600 can proceed to 630.

At 630, a warning signal can be generated. This warning signal can be communicated to one or more devices to indicate that the tasks of the mission are not being completed according to the replacement order. For example, the workflow efficiency system 110 may generate the warning signal and send the warning signal to the operator input device 104. The warning signal may notify the operator that he or she is not completing the tasks of the mission according to the replacement order. The warning signal optionally may provide instructions to the operator as to how to return to completing the tasks according to the replacement order. For example, the warning signal may cause the input device 104 to display instructions to the operator as to which task is to be completed next, where the task is to be completed, and/or where the tool(s) needed to complete the task are located. Optionally, the warning signal may notify one or more other parties, such as another operator who is waiting for the mission to be completed before starting or completing work on another mission, to a supervisor of the operator, or the like.

On the other hand, if the operator is performing the tasks according to the replacement order, then a determination is made (e.g., at 628) as to whether the mission has been completed according to the replacement order of the tasks. If so, then flow of the method 600 may proceed to 632, where the monitoring of the operator stops. But, if the mission has not been completed, then flow of the method 600 may return to 620 for continued monitoring of the operator to determine if the tasks are being completed according to the replacement order.

In one example of the inventive subject matter described herein, a method (e.g., for increasing the efficiency of a mission) includes tracking, with an electronic locating device, movements of an operator while the operator is performing a sequential series of tasks in a first order to complete a mission, examining the movements of the operator and completion of the tasks in the first order with one or more computer processors to determine if the tasks can be completed in a more efficient order than the first order, determining a different, second order of the tasks that is more efficient than the first order in which the tasks were completed when the movements of the operator were tracked, and generating a presentation of the second order of the tasks for display on an electronic mobile device during another performance of the tasks.

In one aspect, the movements of the operator are tracked with a mobile phone that includes the electronic locating device.

In one aspect, the mission includes at least one of repair or maintenance of a vehicle.

In one aspect, the electronic mobile device on which the presentation of the second order of the tasks is displayed comprises at least one of a mobile phone or a tablet computer carried by the operator during the another performance of the tasks.

In one aspect, the second order to complete performance of the tasks is more efficient than the first order when completion of the mission is done with the tasks being performed in the second order takes less time than performance of the tasks in the first order.

In one aspect, tracking the movements of the operator also includes determining times at which at least one of the movements occur or the tasks are completed.

In one aspect, the movements of the operator and completion of the tasks are examined to determine duplicative movements of the operator during performance of the tasks in the first order. The second order to complete performance of the tasks is more efficient than the first order when the second order of the tasks eliminates at least one of the duplicative movements of the operator from the second order of the tasks.

In one aspect, determining the second order of the tasks includes identifying restrictions on which of the tasks must be performed prior to other ones of the tasks.

In one aspect, generating the presentation of the second order includes displaying visual instructions to the operator for one or more of the tasks during a time period that the operator is performing the one or more of the tasks and notifying the operator when the operator deviates from at least one of the second order of the tasks or a movement dictated by the second order of the tasks.

In one aspect, examining the movements of the operator and completion of the tasks includes identifying a change in location for one or more tools used by the operator during completion of the tasks.

In one aspect, one or more (or all) of the operations of the method are performed with one or more processors, such as one or more computer microprocessors that are included in and/or connected with hardware circuitry or circuits.

In another example of the inventive subject matter described herein, a monitoring system includes a location receiving device and one or more computer processors. The location receiving device is configured to track movements of an operator while the operator is performing a sequential series of tasks in a first order to complete a mission. The one or more computer processors are configured to examine the movements of the operator and completion of the tasks in the first order to determine if the tasks can be completed in a more efficient order than the first order, determine a different, second order of the tasks that is more efficient than the first order in which the tasks were completed when the movements of the operator were tracked, and generate a presentation of the second order of the tasks for display on an electronic mobile device during another performance of the tasks.

In one aspect, the location receiving device is configured to track the movements of the operator by communicating with a mobile phone that is with the operator during performance of the tasks.

In one aspect, the mission includes at least one of repair or maintenance of a vehicle.

In one aspect, the electronic mobile device on which the presentation of the second order of the tasks is displayed comprises at least one of a mobile phone or a tablet computer carried by the operator during performance of the mission.

In one aspect, the second order to complete performance of the tasks is more efficient than the first order when completion of the mission is done with the tasks being performed in the second order takes less time than performance of the tasks in the first order.

In one aspect, the location receiving device is configured to track the movements of the operator and times at which at least one of the movements occur or the tasks are completed.

In one aspect, the one or more processors are configured to determine duplicative movements of the operator during performance of the tasks in the first order. The second order of the tasks is more efficient than the first order when the second order eliminates at least one of the duplicative movements of the operator from the second order of the tasks.

In one aspect, the one or more processors are configured to identify restrictions on which of the tasks must be performed prior to other ones of the tasks.

In one aspect, the one or more processors are configured to identify a change in location for one or more tools used by the operator during completion of the tasks according to the second order.

In another example of the inventive subject matter descried herein, a method for increasing the efficiency at which a mission is completed includes identifying a previous order in which a series of tasks of a mission on a first vehicle were performed using tools and movements of an operator who performed the series of tasks in the previous order, and determining an alternate order to complete the series of tasks of the mission on a second vehicle. The alternate order includes at least one of a different sequence of the tasks or a different location of at least one of the tools. Completing the mission according to the alternate order of the tasks consumes less time than completing the mission according to the previous order of the tasks. The method also can include instructing, via a mobile electronic device that includes one or more computer processors, the operator how to move between the tools and the tasks according to the alternate order of the tasks during performance of the mission on the second vehicle, monitoring movements of the operator and completion of the tasks during performance of the mission on the second vehicle, and communicating a warning signal to the mobile electronic device responsive to determining that the operator is not performing the tasks of the mission according to the alternate order of the tasks.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A method, comprising:
tracking, with an electronic locating device, movements of an operator while the operator is performing a sequential series of tasks in a first order to complete a mission;
examining the movements of the operator and completion of the tasks in the first order with one or more computer processors to determine if the tasks can be completed in a more efficient order than the first order;
determining a different, second order of the tasks that is more efficient than the first order in which the tasks were completed when the movements of the operator were tracked; and
generating a presentation of the second order of the tasks for display on an electronic mobile device during another performance of the tasks.

2. The method of claim 1, wherein the movements of the operator are tracked with a mobile phone that includes the electronic locating device.

3. The method of claim 1, wherein the mission includes at least one of repair or maintenance of a vehicle.

4. The method of claim 1, wherein the electronic mobile device on which the second order of the tasks is displayed comprises at least one of a mobile phone or a tablet computer carried by the operator during the another performance of the tasks.

5. The method of claim 1, wherein the second order to complete performance of the tasks is more efficient than the first order when completion of the mission is done with the tasks being performed in the second order takes less time than performance of the tasks in the first order.

6. The method of claim 1, wherein tracking the movements of the operator also includes determining times at which at least one of the movements occur or the tasks are completed.

7. The method of claim 1, wherein the movements of the operator and completion of the tasks are examined to determine duplicative movements of the operator during performance of the tasks in the first order, wherein the second order to complete performance of the tasks is more efficient than the first order when the second order of the tasks eliminates at least one of the duplicative movements of the operator from the second order of the tasks.

8. The method of claim 1, wherein determining the second order of the tasks includes identifying restrictions on which of the tasks must be performed prior to other ones of the tasks.

9. The method of claim 1, wherein generating the presentation of the second order includes displaying visual instructions to the operator for one or more of the tasks during a time period that the operator is performing the one or more of the tasks and notifying the operator when the operator deviates from at least one of the second order of the tasks or a movement dictated by the second order of the tasks.

10. The method of claim 1, wherein examining the movements of the operator and completion of the tasks includes identifying a change in location for one or more tools used by the operator during completion of the tasks.

11. A system comprising:
a location receiving device configured to track movements of an operator while the operator is performing a sequential series of tasks in a first order to complete a mission; and
one or more computer processors configured to examine the movements of the operator and completion of the tasks in the first order to determine if the tasks can be completed in a more efficient order than the first order, determine a different, second order of the tasks that is more efficient than the first order in which the tasks were completed when the movements of the operator were tracked, and generate a presentation of the second order of the tasks for display on an electronic mobile device during another performance of the tasks.

12. The system of claim 11, wherein the location receiving device is configured to track the movements of the operator by communicating with a mobile phone that is with the operator during performance of the tasks.

13. The system of claim 11, wherein the mission includes at least one of repair or maintenance of a vehicle.

14. The system of claim 11, wherein the electronic mobile device on which the presentation of the second order of the tasks is displayed comprises at least one of a mobile phone or a tablet computer carried by the operator during performance of the mission.

15. The system of claim 11, wherein the second order to complete performance of the tasks is more efficient than the first order when completion of the mission is done with the tasks being performed in the second order takes less time than performance of the tasks in the first order.

16. The system of claim 11, wherein the location receiving device is configured to track the movements of the operator and times at which at least one of the movements occur or the tasks are completed.

17. The system of claim 11, wherein the one or more processors are configured to determine duplicative movements of the operator during performance of the tasks in the first order, wherein the second order of the tasks is more efficient than the first order when the second order eliminates at least one of the duplicative movements of the operator from the second order of the tasks.

18. The system of claim 11, wherein the one or more processors are configured to identify restrictions on which of the tasks must be performed prior to other ones of the tasks.

19. The system of claim 11, wherein the one or more processors are configured to identify a change in location for one or more tools used by the operator during completion of the tasks according to the second order.

20. A method comprising:
identifying a previous order in which a series of tasks of a mission on a first vehicle were performed using tools and movements of an operator who performed the series of tasks in the previous order;
determining an alternate order to complete the series of tasks of the mission on a second vehicle, the alternate order including at least one of a different sequence of the tasks or a different location of at least one of the tools, wherein completing the mission according to the alternate order of the tasks consumes less time than completing the mission according to the previous order of the tasks;
instructing, via a mobile electronic device that includes one or more computer processors, the operator how to move between the tools and the tasks according to the alternate order of the tasks during performance of the mission on the second vehicle;
monitoring movements of the operator and completion of the tasks during performance of the mission on the second vehicle; and
communicating a warning signal to the mobile electronic device responsive to determining that the operator is not performing the tasks of the mission according to the alternate order of the tasks.
